(19) United States
(12) Patent Application Publication
(10) Pub. No.: US 2003/0084133 A1
(43) Pub. Date: May 1, 2003

(54) Remote console for controlling computers via a network

(76) Inventors: Sen-Ta Chan, Taipei Hsien (TW); Chine-Shan Huang, Taipei Hsien (TW); Wen-Pin Huang, Taipei Hsien (TW); Li-We Pan, Taipei Hsien (TW); Che Jung Chang, Taipei Hsien (TW); Chu Tsung Hsein, Taipei Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 09/683,843

(22) Filed: Feb. 21, 2002

(30) Foreign Application Priority Data
Oct. 25, 2001 (TW) 090126449

(51) Int. Cl. G06F 15/177

(52) U.S. Cl. 709/222

(57) ABSTRACT

A remote console is used to control power-on processes of a plurality of computers connected to a network. The remote console has an input device for generating an input control signal of the power-on process for the computer, an output device for displaying a corresponding output video signal of the power-on process for the computer, and a remote console manager for processing signals of the computer and controlling operations of the computer. The remote console manager has an output receiving module for receiving output video data from the computer via the network, a second conversion module for converting the generated input control signal into input control data and restoring the output video data to the corresponding output video signal, and an input transferring module for transferring the input control data to the computer via the network.

### BACKGROUND OF THE INVENTION

1. Field of the Invention

The invention relates to a remote console, and more particularly, to a remote console for controlling computers via a network.

2. Description of the Prior Art

Both individuals and companies use computers for everyday needs. For accessing a huge amount of information frequently, a company typically uses servers to process the accessing of information. Generally, the servers are rack mountable servers which are placed into a rack for convenient management and installation. However, it is not possible for each of the servers to be equipped with a respective keyboard, display, and mouse since these peripheral devices occupy considerably large areas. Additionally, the servers are merely used to receive requests of terminal computers via a network so as to execute corresponding data processes. Therefore, even if the severs are not equipped with the respective peripheral devices, the servers can still be operated normally. On the other hand, if each of the servers is equipped with a respective keyboard, display, and mouse, the resources of the company are wasted and the expenses of the company are thus increased significantly.

Consequently, an administrator of servers generally utilizes a KVM (keyboard/video/mouse) switch to manage a plurality of servers. Each of the servers is connected to the KVM switch via a keyboard cable, a video cable, and a mouse cable. Meanwhile, a control console, which is equipped with a keyboard, a display, and a mouse, is connected to each of the servers via the KVM switch so as to control and manage the servers. Furthermore, for providing remote control capability, the control console can manage and control remote computers via a network.

Please refer to FIG. 1. FIG. 1 is a schematic diagram of a prior art KVM switch system. A plurality of servers 10 are connected to a KVM switch 14 through a wiring 12 and are connected to a network 16 through another wiring 20. Meanwhile, the KVM switch 14 is connected to the network 16 through a wiring 15 and comprises a digital/analog (D/A) converter 21 for converting a digital signal to an analog signal and an analog/digital (A/D) converter 22 for converting an analog signal to a digital signal. Furthermore, a remote control computer 18 is connected to the network 16 through a wiring 19. Therefore, the remote control computer 18 and the KVM switch 14 can transmit signals to each other through the network 16. Consequently, the KVM switch 14 can select each of the servers 10 to be joined with the remote control computer 18. Then, the remote control computer 18 can thus further manage a plurality of the servers 10 remotely via the KVM switch 14.

However, the KVM switch 14 is restricted by its hardware specification, leading that the amount of the servers 10 which can be connected to the KVM switch 14 has an upper limit. When the amount of the servers 10 exceeds the upper limit of the KVM switch 14, the number of the KVM switch 14 has also to be increased so that each of the servers 10 can be controlled by the respective KVM switches 14. Furthermore, each of the KVM switches 14 has to comprise a mapping table for realizing which port corresponds to which server 10. With this infrastructure in place, the KVM switch 14 can accurately switch to and manage the desired server 10. Moreover, since each of the servers 10 has to utilize the respective wiring 12 to connect to the KVM switch 14, the cost of the KVM switch system is increased and a mess is caused by the wirings. Additionally, the prior art KVM switch 14 has to use the D/A converter 21 to convert a digital signal transmitted from the remote control computer 18 to a corresponding analog signal. Likewise, an analog signal of the server 10 has to be converted through the A/D converter 22 to a digital signal and then be transmitted to the remote control computer 18 via the network 16. When the KVM switch 14 transmits a signal, the KVM switch 14 has to firstly determine the specification of each output interface, such as a PS/2 interface or a USB interface. Then, a corresponding signal is converted according to the specification of the interface so as to output a compatible signal. Consequently, since the KVM switch 14 has to determine the specification of the output interfaces and then convert signals, the operational period is prolonged, and the efficiency of the remote control is thus decreased substantially. For these reasons, the management of remote computers is inconvenient.

### SUMMARY OF INVENTION

It is therefore a primary objective of the claimed invention to provide a remote console for controlling a plurality of terminal computers via a network to solve the above-mentioned problem.

According to the claimed invention, a remote console for controlling power-on processes of a plurality of computers connected to a network is disclosed. Each of the computers comprises a basic input/output system (BIOS) for executing a power-on process of the computer, an input buffer for storing input control signals, an output buffer for storing output video signals, and a virtual POST (power-on self test) daemon embedded in the basic input/output system for processing signals of the computer and receiving controls of the remote console. The virtual POST daemon comprises an input receiving module for receiving input control data from the remote console via the network, an input detection module for detecting whether the input buffer has any input control signals and executing the input control signals, a first conversion module for converting the output video signal stored in the output buffer into output video data and restoring the received input control data to the input control signal and then storing the input control signal in the input buffer, and an output transferring module for transferring the output video data to the remote console via the network. The remote console comprises an input device for generating the input control signal of the power-on process for the computer, an output device for displaying the corresponding output video signal of the power-on process for the computer, and a remote console manager for processing signals of the computer and controlling operations of the computer. The remote console manager comprises an output receiving module for receiving the output video data from the computer via the network, a second conversion module for converting the generated input control signal into the input control data and restoring the output video data to the corresponding output video signal, and an input transferring module for transferring the input control data to the computer via the network. The input control signal generated by the input device of the remote console is transferred to the virtual POST daemon of the computer via the network for controlling operations of the BIOS, and the virtual POST daemon transfers an output signal of the computer to the output device of the remote console via the network for displaying a power-on status of the computer.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a schematic diagram of a KVM switch system according to the prior art.

FIG. 2 is a functional block diagram of a KVM over network according to the present invention.

FIG. 3 is a flow chart of the KVM over network according to the present invention.

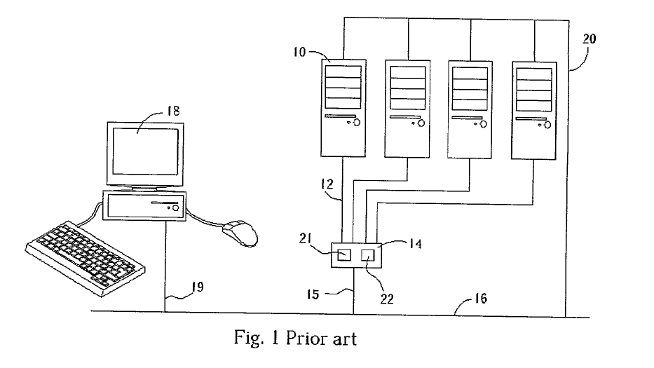

### DETAILED DESCRIPTION

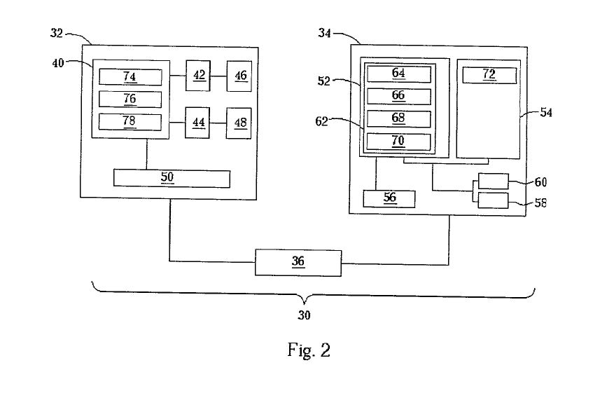

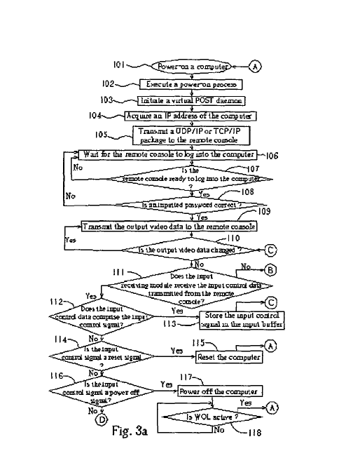

Please refer to FIG. 2. FIG. 2 is a functional block diagram of a KVM over network 30 according to the present invention. The KVM over network 30 comprises a remote console 32, a plurality of computers 34, and a network 36. Please note that the computer 34 shown in FIG. 2 is merely used to illustrate the preferred embodiment of the present invention, but more than one computer can also be utilized in the present invention without departing from the spirit of the present invention. The remote console 32 comprises a remote console manager 40 for processing signals transmitted from the computer 34 and controlling operations of the computer 34, an input buffer 42 for storing an input control signal, an output buffer 44 for storing an output video signal, an input device 46 for generating the input control signal, an output device 48 for generating the corresponding output video signal, and a network device 50 connected to the network 36.

The computer 34 comprises a basic input/output system (BIOS) 52 for executing a power-on process of the computer 34, an operating system (OS) 54 for controlling the operations of the computer 34, a network device 56 connected to the network 36, an input buffer 58 for storing the input control signals, and an output buffer 60 for storing the output video signals. The BIOS 52 further comprises a virtual POST (power-on self test) daemon 62 for providing a network function during the execution of the power-on process. The virtual POST daemon 62 comprises an input receiving module 64 for receiving input control data from the remote console 32 via the network 36, an input detection module 66 for detecting whether the input buffer 58 has any input control signals and executing the input control signals, a first conversion module 68 for converting the output video signal stored in the output buffer 60 into output video data and restoring the received input control data to the input control signal and then storing the input control signal in the input buffer 58, and an output transferring module 70 for transferring the output video data to the remote console 32 via the network 36.

The remote console manager 40 comprises an output receiving module 74 for receiving the output video data transmitted from the computer 34 via the network 36, a second conversion module 76 for converting the input control signal generated from the remote console 32 into the input control data and restoring the output video data to the corresponding output video signal, and an input transferring module 78 for transferring the input control data to the computer 34 via the network 36. Moreover, the OS 54 further comprises a virtual OS KVM daemon 72 for providing the network function for an operation status of the computer 34 to be transferred to the remote console 32 via the network 36, and for receiving a command transmitted from the remote console 32 via the network 36 for controlling an operation procedure of the computer 34.

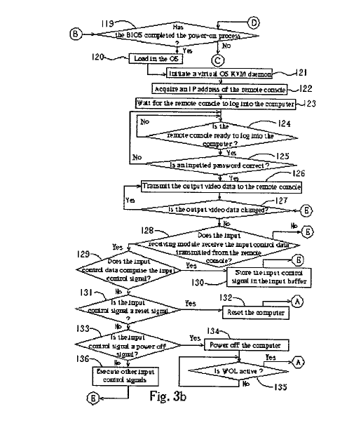

Please refer to FIGS. 2, 3a, and 3b. FIGS. 3a and 3b are flow charts of the KVM over network 30 according to the present invention. The procedure comprises the following steps, and letters A, B, C, D, and E are connection points of FIGS. 3a and 3b:step 101: power-on the computer 34 via a power switch or the network 36; step 102: the BIOS 52 starts to execute the power-on process of the computer 34; step 103: load in and then initiate the virtual POST daemon 62 of the computer 34; step 104: acquire an IP address of the computer 34 by utilizing a dynamic host configuration protocol (DHCP); step 105: the virtual POST daemon 62 transmits an UDP/IP or TCP/IP package that includes the IP address of the computer 34 to the remote console manager 40 of the remote console 32 via the network 36; step 106: the computer 34 waits for the remote console 32 to log into the computer 34; step 107: if the remote console 32 is ready to log into the computer 34, go to step 108, if not, go to step 106; step 108: if an inputted password is correct, go to step 109, if not, go to step 106; step 109: the first conversion module 68 converts the output video signal stored in the output buffer 60 into the output video data and then the output transferring module 70 transmits the output video data to the output receiving module 74 of the remote console 32 via the network 36; step 110: if the output video signal stored in the output buffer 60 of the computer 34 is changed, go to step 109, if not, go to step 111; step 111: if the input receiving module 64 of the virtual POST daemon 62 receives the input control data transmitted from the remote console 32, go to step 112, if not, go to step 119; step 112: if the input control data comprises the input control signal, go to step 113, if not, go to step 114; step 113: the first conversion module 68 converts the input control data into the input control signal and stores the input control signal in the input buffer 58, go to step 110; step 114: the input detection module 66 of the computer 34 detects that if the input control signal in the input buffer 58 is a reset signal, go to step 115, if not, go to step 116; step 115: reset the computer 34, go to step 101; step 116: if the input detection module 66 of the computer 34 detects that the input control signal in the input buffer 58 is a power-off signal, go to step 117, if not, go to step 119; step 117: power-off the computer 34; step 118: if a wakeup on local area network (LAN)(WOL) is active, go to step 101, if not, go to step 118; step 119: if the BIOS 52 has completed the power-on process of the computer 34, go to step 120, if not, go to step 110; step 120: load in the OS 54; step 121: initiate the virtual OS KVM daemon 72; step 122: acquire an IP address of the remote console 32 via the BIOS 52; step 123: transmit an UDP/IP or TCP/IP package that includes the IP address of the remote console 32 to the computer 34 and wait for the remote console 32 to log into the computer 34; step 124: if the remote console 32 is ready to log into the computer 34, go to step 125, if not, go to step 124; step 125: if an inputted password is correct, go to step 126, if not, go to step 124; step 126: the first conversion module 68 converts the output video signal stored in the output buffer 60 into the output video data and then the output transferring module 70 transmits the output video data to the output receiving module 74 of the remote console 32 via the network 36; step 127: if the output video signal stored in the output buffer 60 of the computer 34 is changed, go to step 126, if not, go to step 128; step 128: if the input receiving module 64 of the virtual POST daemon 62 receives the input control data transmitted from the remote console 32, go to step 129, if not, go to step 127; step 129: if the input control data comprises the input control signal, go to step 130, if not, go to step 131; step 130: the first conversion module 68 converts the input control data into the input control signal and stores the input control signal in the input buffer 58, go to step 127; step 131: the input detection module 66 of the computer 34 detects that if the input control signal in the input buffer 58 is a reset signal, go to step 132, if not, go to step 133; step 132: reset the computer 34, then go to step 101; step 133: the input detection module 66 of the computer 34 detects that if the input control signal in the input buffer 58 is a power-off signal, go to step 134, if not, go to step 136; step 134: power-off the computer 34; step 135: if the WOL is active, go to step 101, if not, go to step 135; step 136: the input detection module 66 of the computer 34 detects other input control signal in the input buffer 58 and executes the input control signal, then go to step 127.

When the first conversion module 68 of the computer 34 converts the output video signal stored in the output buffer 60 into the output video data and then the output transferring module 70 transmits the output video data to the output receiving module 74 of the remote console 32 via the network 36, the second conversion module 76 of the remote console 32 restores the output video data to the corresponding output video signal and stores the output video signal in the output buffer 44. Thereafter, the output device 48 displays image through reading the output video signal in the output buffer 44. When a user inputs the input control signal, which controls the operations of the computer 34, through the input device 46, the input control signal is firstly stored in the input buffer 42, and then the second conversion module 76 of the remote console manager 40 converts the input control signal in the input buffer 42 into the input control data and the input transferring module 78 transmits the input control data to the computer 34.

According to the preferred embodiment, the input device 46 of the remote console 32 may be a keyboard or a pointing device, such as a mouse or a trackball. When the input control signal transmitted by the remote console 32 is a double-click signal, the double-click signal is then stored in the input buffer 58 of the computer 34 and generates a corresponding double-click control on the computer 34.

In summary, the KVM over network 30 of the present invention utilizes the virtual POST daemon 62 inside the BIOS 52 to provide the network function during the POST process for transmitting a local screen video stored in the output buffer 60 of the computer 34 to the remote console manager 40 of the remote console 32. Then, the local screen video of the computer 34 is displayed on the output device 48 of the remote console 32. Thus, an administrator can control the power-on status of the computer 34 from the output device 48 of the remote console 32. Meanwhile, the administrator can also utilize the input device 46 of the remote console 32 to input the input control signal. The input control signal is then transmitted to the virtual OS KVM daemon 72 of the computer 34 via the network 36 and is stored in the input buffer 58 so as to control the power-on process of the computer 34.

Likewise, when the computer 34 has completed the power-on process and loaded in the OS 54, the virtual OS KVM daemon 72 of the OS 54 then transmits the local screen video stored in the output buffer 60 of the computer 34 to the remote console manager 40 of the remote console 32 via the network 36. Thus, the administrator can control the operation status of the computer 34 from the output device 48 of the remote console 32. Meanwhile, the administrator can also utilize the input device 46 of the remote console 32 to input the input control signal. The input control signal is then transmitted to the virtual OS KVM daemon 72 of the computer 34 via the network 36 and is stored in the input buffer 58 so as to control the operations of the OS 54 and the execution of programs in the computer 34. Additionally, when the computer 34 is in a power-off status, the remote console 32 can utilize the prior art WOL technique to power-on the computer 34 so that the computer 34 is re-entered into the power-on process. Therefore, the remote console 32 can manage the operations of the computer 34 through the virtual POST daemon 62 of the BIOS 52.

For managing a plurality of computers 34 remotely, the KVM over network 30 according to the present invention can automatically detect whether each of the computers 34 connected to the network 36 can support the virtual POST daemon 52 or the virtual OS KVM daemon 72. Since the remote console 32 can transmit the UDP/IP or TCP/IP package to the network 36 previously, the computer 34 that can support the KVM over network 30 of the present invention can be automatically added to a list. Thus, the administrator can utilize the list to directly select the computers 34 to be managed. Surely, the administrator can also add the computers 34 in the list manually.

According to the preferred embodiment, the network 36 is an Internet or a LAN, and the computer 34 and the remote console 32 may be a personal computer (PC), a desktop computer, a server, a workstation, or a notebook.

In contrast to the prior art KVM switch, a KVM over network according to the present invention embeds a virtual POST daemon into a BIOS and a virtual OS KVM daemon into an OS so as to form a virtual KVM switch. Therefore, an administrator can remotely manage a power-on process, a power-off process, or any other operations of computers via a network. Since the prior art KVM switch has an upper limit of computers it can connect to, a plurality of KVM switches are required when the amount of the computers is huge. Thus, the cost of the prior art KVM switch is increased. Conversely, the KVM over network of the present invention utilizes the network to manage the remote computers so that each of the computers connected to the network can be managed by using the KVM over network of the present invention. The requirement of the hardware for the switches is thus decreased and the cost is decreased as well. Furthermore, since the present invention KVM over network utilizes the network to transmit input and output signals, extra keyboard cables, mouse cables, or video cables are not required any more so as to solve the prior art arrangement problem. Moreover, each of the prior art KVM switches has to comprise a mapping table for realizing which port corresponds to which server. However, the present invention can utilize different IP addresses of the computers to distinguish between the different computers. Thus, the present invention KVM over network can directly select each of the computers through the network and establish a list for the computers. That is, the mapping table is not required and the management of the computers is much easier.

Additionally, the prior art KVM switch has to use the D/A converter and the A/D converter to convert an output video signal of the computer or an input control signal of the remote console appropriately. When the KVM switch transmits the signals, the KVM switch has to first determine the specification of each output interface so as to generate a compatible input control signal and a compatible output video signal. Conversely, since the output video signal stored in the output buffer of the computer is directly transmitted to the output buffer of the remote console and the input control signal of the input buffer of the remote console is directly transmitted to the input buffer of the computer, the present invention KVM over network can directly control peripheral devices through reading data of the output buffer and input buffer. Consequently, the KVM over network of the present invention does not need to convert the data for adapting to the peripheral devices with different specifications. The efficiency of the remote control is thus increased substantially, and remote computers can be managed more conveniently and rapidly.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A remote console for controlling power-on processes of a plurality of computers connected to a network, each of the computers comprising:
a basic input/output system (BIOS) for executing a power-on process of the computer;
an input buffer for storing input control signals;
an output buffer for storing output video signals; and
a virtual POST (power-on self test) daemon embedded in the basic input/output system for processing signals of the computer and receiving controls of the remote console, the virtual POST daemon comprising:
an input receiving module for receiving input control data from the remote console via the network;
an input detection module for detecting whether the input buffer has any input control signals and executing the input control signals;
a first conversion module for converting the output video signal stored in the output buffer into output video data and restoring the received input control data to the input control signal and then storing the input control signal in the input buffer; and
an output transferring module for transferring the output video data to the remote console via the network;
the remote console comprising:
an input device for generating the input control signal of the power-on process for the computer;
an output device for displaying the corresponding output video signal of the power-on process for the computer; and
a remote console manager for processing signals of the computer and controlling operations of the computer, the remote console manager comprising:
an output receiving module for receiving the output video data from the computer via the network;
a second conversion module for converting the generated input control signal into the input control data and restoring the output video data to the corresponding output video signal; and
an input transferring module for transferring the input control data to the computer via the network;
wherein the input control signal generated by the input device of the remote console is transferred to the virtual POST daemon of the computer via the network for controlling operations of the BIOS, and the virtual POST daemon transfers an output signal of the computer to the output device of the remote console via the network for displaying a power-on status of the computer.

2. The remote console of claim 1 wherein the input device is a keyboard.

3. The remote console of claim 1 wherein the input device is a pointing device.

4. The remote console of claim 3 wherein the pointing device is selected from a group consisting of a mouse and a trackball.

5. The remote console of claim 1 wherein the computer further comprises:
an operating system (OS) for controlling operations of the computer; and
a virtual OS KVM daemon installed in the OS for providing a network function, an operation status of the computer being transferred to the remote console via the network, and for providing a command received from the remote console via the network for controlling an operation procedure of the computer;
wherein the input control signal generated by the input device of the remote console is transferred to the virtual POST daemon of the computer via the network, and the virtual POST daemon of the computer transfers the operation status of the computer to the output device of the remote console via the network.

6. The remote console of claim 1 wherein the network is selected from a group consisting of an Internet and a local area network (LAN).

7. The remote console of claim 1 wherein the computer is selected from a group consisting of a personal computer (PC), a server, and a notebook.

8. The remote console of claim 1 wherein the remote console is capable of executing a power-on process for the computer via the network.

9. The remote console of claim 1 wherein the remote console is selected from a group consisting of a PC, a workstation, and a notebook.

10. The remote console of claim 1 wherein a password is stored in the computer, when the remote console logs into the computer, the remote console has to input an identical password via the input device to execute a verification procedure.

11. A method of using a remote console for controlling power-on processes of a plurality of computers connected to a network, the remote console comprising an input device for generating an input control signal of a power-on process for the computer, each of the computers executing the following steps:
using a basic input/output system (BIOS) for executing the power-on process of the computer;
using an input receiving module for receiving input control data from the remote console via the network;
using an input detection module for detecting whether an input buffer has any input control signals and executing the input control signals;
using a first conversion module for converting an output video signal stored in an output buffer into output video data and restoring the received input control data to the input control signal and then storing the input control signal in the input buffer; and
using an output transferring module for transferring the output video data to the remote console via the network.

12. The method of claim 11 wherein the input device is a keyboard.

13. The method of claim 11 wherein the input device is a pointing device.

14. The method of claim 13 wherein the pointing device is selected from a group consisting of a mouse and a trackball.

15. The method of claim 11 wherein the computer further comprises:
an operating system (OS) for controlling operations of the computer; and
a virtual OS KVM daemon installed in the OS for providing a network function, an operation status of the computer being transferred to the remote console via the network, and for providing a command received from the remote console via the network for controlling an operation procedure of the computer;
wherein the input control signal generated by the input device of the remote console is transferred to the virtual POST daemon of the computer via the network, and the virtual POST daemon of the computer transfers the operation status of the computer to an output device of the remote console via the network.

16. The method of claim 11 wherein the network is selected from a group consisting of an Internet and a local area network (LAN).

17. The method of claim 11 wherein the computer is selected from a group consisting of a personal computer (PC), a server, and a notebook.

18. The method of claim 11 wherein the remote console is capable of executing a power-on process for the computer via the network.

19. The method of claim 11 wherein the remote console is selected from a group consisting of a PC, a workstation, and a notebook.

20. The method of claim 11 wherein a password is stored in the computer, when the remote console logs into the computer, the remote console has to input an identical password via the input device to execute a verification procedure.

21. A method of using a remote console for controlling power-on processes of a plurality of computers connected to a network, the remote console executing the following steps:
using an input device for generating an input control signal of the power-on process for the computer;
using an output receiving module for receiving output video data from the computer via the network;
using a second conversion module for converting the generated input control signal into input control data and restoring the output video data to the corresponding output video signal;
using an input transferring module for transferring the input control data to the computer via the network; and
using an output device for displaying the corresponding output video signal of the power-on process for the computer.

22. The method of claim 21 wherein the input device is a keyboard.

23. The method of claim 21 wherein the input device is a pointing device.

24. The method of claim 23 wherein the pointing device is selected from a group consisting of a mouse and a trackball.

25. The method of claim 21 wherein the computer further comprises:
an operating system (OS) for controlling operations of the computer; and
a virtual OS KVM daemon installed in the OS for providing a network function, an operation status of the computer being transferred to the remote console via the network, and for providing a command received from the remote console via the network for controlling an operation procedure of the computer;
wherein the input control signal generated by the input device of the remote console is transferred to the virtual POST daemon of the computer via the network, and the virtual POST daemon of the computer transfers the operation status of the computer to an output device of the remote console via the network.

26. The method of claim 21 wherein the network is selected from a group consisting of an Internet and a local area network (LAN).

27. The method of claim 21 wherein the computer is selected from a group consisting of a personal computer (PC), a server, and a notebook.

28. The method of claim 21 wherein the remote console is capable of executing a power-on process for the computer via the network.

29. The method of claim 21 wherein the remote console is selected from a group consisting of a PC, a workstation, and a notebook.

30. The method of claim 21 wherein a password is stored in the computer, when the remote console logs into the computer, the remote console has to input an identical password via the input device to execute a verification procedure.

31. A remote console for controlling a plurality of computers connected to a network, each of the computers comprising:
a basic input/output system (BIOS) for executing a power-on process of the computer;
a plurality of buffers for storing input and output signals; and
a virtual POST (power-on self test) daemon embedded in the basic input/output system for providing a network function, the input signal for controlling the power-on process of the computer being received from the remote console via the network and stored in the buffer, and the output signal stored in the buffer of the computer being transferred to the remote console via the network; the remote console comprising:
a remote console manager for processing signals transferred from the computer and controlling operations of the computer; and
a plurality of peripheral devices for outputting the output signal transferred from the computer and generating the input signal which controls the power-on process of the computer;
wherein the input signal generated by the peripheral devices of the remote console is transferred to the virtual POST daemon of the computer via the network for controlling operations of the BIOS, and the virtual POST daemon of the computer transfers the output signal to the peripheral devices of the remote console via the network for displaying a power-on status of the computer.

32. The remote console of claim 31 wherein the buffer comprises an input buffer for storing input control signals, and an output buffer for storing output video signals.

33. The remote console of claim 31 wherein the peripheral devices comprise a plurality of input devices and a plurality of output devices.

34. The remote console of claim 31 wherein the computer further comprises:
an operating system (OS) for controlling operations of the computer; and
a virtual OS KVM daemon installed in the OS for providing a network function, an operation status of the computer being transferred to the remote console via the network, and for providing a command received from the remote console via the network for controlling an operation procedure of the computer;
wherein the input control signal generated by the input device of the remote console is transferred to the virtual POST daemon of the computer via the network, and the virtual POST daemon of the computer transfers the operation status of the computer to the output device of the remote console via the network.

35. The remote console of claim 31 wherein the remote console is capable of executing the power-on process for the computer via the network.

36. A method of using a remote console for controlling a plurality of computers connected to a network, each of the computers comprising:
a basic input/output system (BIOS) for executing a power-on process of the computer;
a plurality of buffers for storing input and output signals; and
a virtual POST (power-on self test) daemon embedded in the basic input/output system for providing a network function, the input signal for controlling the power-on process of the computer being received from the remote console via the network and stored in the buffer, and the output signal stored in the buffer of the computer being transferred to the remote console via the network;
the remote console comprising:
a remote console manager for processing signals transferred from the computer and controlling operations of the computer; and
a plurality of peripheral devices for outputting the output signal transferred from the computer and generating the input signal which controls the power-on process of the computer;
the method comprising:
using the virtual POST daemon for transferring the output signal stored in the buffer to the remote console manager of the remote console via the network, and displaying a power-on status of the computer via the peripheral devices of the remote console; and
using the remote console manager of the remote console for transferring the input signal generated from the peripheral devices of the remote console to the virtual POST daemon of the computer, and storing the input signal in the buffer by the virtual POST daemon so as to control the power-on process of the computer.

37. The method of claim 36 wherein the buffer comprises an input buffer for storing input control signals, and an output buffer for storing output video signals.

38. The method of claim 36 wherein the peripheral devices comprise a plurality of input devices and a plurality of output devices.

39. The method of claim 36 wherein the computer further comprises:
an operating system (OS) for controlling operations of the computer; and
a virtual OS KVM daemon installed in the OS for providing a network function, an operation status of the computer being transferred to the remote console via the network, and for providing a command received from the remote console via the network for controlling an operation procedure of the computer;
wherein the input control signal generated by the input device of the remote console is transferred to the virtual POST daemon of the computer via the network, and the virtual POST daemon of the computer transfers the operation status of the computer to the output device of the remote console via the network.

40. The method of claim 36 wherein the remote console is capable of executing the power-on process for the computer via the network.
